(19) United States
(12) Patent Application Publication
(10) Pub. No.: US 2011/0214991 A1
(43) Pub. Date: Sep. 8, 2011

(54) MICROFLUIDIC DEVICE AND METHOD OF DETERMINING NUCLEOTIDE SEQUENCE OF TARGET NUCLEIC ACID USING THE SAME

(75) Inventors: Suhyeon KIM, Seoul (KR); Joo-won RHEE, Yongin-si (KR)

(73) Assignee: SAMSUNG ELECTRONICS CO., LTD., Suwon-si (KR)

(21) Appl. No.: 13/038,760

(22) Filed: Mar. 2, 2011

(30) Foreign Application Priority Data
Mar. 5, 2010 (KR) 10-2010-0020067

(51) Int. Cl. G01N 27/453; G01N 27/447

(52) U.S. Cl. 204/452; 204/603

(57) ABSTRACT

A microfluidic device includes at least one first channel and at least one second channel or chamber which is connected to the first channel via a nanopore in a fluid communication manner, and a method of determining a nucleotide sequence of a target nucleic acid by using the same. Accordingly, the nucleotide sequence of the target nucleic acid may be efficiently determined.

### CROSS-REFERENCE TO RELATED APPLICATIONS

This application claims priority to Korean Patent Application No. 10-2010-20067, filed on Mar. 5, 2010, and all the benefits accruing therefrom under 35 USC 119, the content of which in its entirety is herein incorporated by reference.

### BACKGROUND

1. Field

The present disclosure relates to a microfluidic device and a method of determining a nucleotide sequence of a target nucleic acid by using the same.

2. Description of the Related Art

A gene is made up of, in its most essential form, a linear alignment of four types of nucleotides which are distinguished from each other by base, i.e., adenine, cytosine, guanine, and thymine. Two of the most widely used gene sequencing techniques are a chain termination method and a chemical degradation method. However, theses methods are cost- and time-consuming since a limited size of the nucleotide sequence of DNA can be determined at once, and thereby they are not suitable for sequencing a high-volume target sequence, for example, for the human genome project personal genome sequencing. By using a next generation sequencing (“NGS”) technique introduced in 2005 and which does not use the chain termination method developed by Sanger, et al., the volume of gene sequencing is rapidly increased, and costs for sequencing the genes are reduced.

NGS techniques are classified into second-generation sequencing and third-generation sequencing. According to the second-generation sequencing using DNA clones, most of cloned DNA is involved in reaction, and thus a cycling reaction is required. However, according to the third-generation sequencing using a single DNA, cloned DNA is not required, and thus, the sequencing process may be conducted in various ways. Sequencing using nanopores is the most efficient method among the third-generation sequencing techniques. However, a single DNA molecule passes through the nanopores too quickly to provide a sufficient detection time for determining the nucleotide sequence of DNA.

In this regard, according to a sequencing method using nanopores, a voltage applied between ends of a nanopore is reduced, temperature is reduced, viscosity of a solution is increased, or an optical tweezer or magnetic tweezer is used. As another sequencing method using nanopores, a method of controlling the velocity of DNA migration by moving one base of DNA at a time by electrical adjustment is disclosed. However, according to these methods, even though the velocity of a single DNA molecule passing through a nanopore is reduced, the velocity may not be constant. Since DNA approaches the nanopore by diffusion, a large amount of a sample is required.

Thus, there is still a need to develop a method and device for efficiently determining the nucleotide sequence of a target nucleic acid.

### SUMMARY

Provided are a microfluidic device including: at least one first channel and at least one second channel or chamber which is connected to the first channel via a nanopore in a fluid communication manner and a method of determining a nucleotide sequence of a target nucleic acid using the same.

Additional aspects will be set forth in part in the description which follows and, in part, will be apparent from the description, or may be learned by practice of the presented embodiments.

According to an embodiment, a microfluidic device includes at least one first channel and at least one second channel or chamber which is connected to the first channel via a nanopore in a fluid communication manner.

According to another embodiment, there is provided a method of determining a nucleotide sequence of a target nucleic acid by using the microfluidic device.

In an embodiment, a microfluidic device comprises at least one first channel; and at least one second channel or chamber connected to the first channel via a nanopore in a fluid communication manner, wherein a first electrode and a second electrode are disposed in the first channel for applying a voltage in the lengthwise direction of the first channel, a first detector that detects a material in the first channel is disposed over the first channel, a third electrode is disposed in the second channel or chamber to be paired with the first or second electrode for applying a voltage between the first and third electrodes or between the second and third electrodes, and a second detector that detects a material passing through the nanopore is disposed in the nanopore.

In another embodiment, a method of determining a nucleotide sequence of a target nucleic acid comprises linking a nanoparticle comprising a detectable label to a 5′ or 3′ end of a target nucleic acid having a nucleotide sequence to be detected; injecting the target nucleic acid linked to the nanoparticle into a first channel as described above; applying a voltage between a first electrode and a second electrode of the microfluidic device; detecting a signal generated from the nanoparticle comprising the detectable label and linked to the target nucleic acid passing through the first channel; and introducing an end of the target nucleic acid which is not linked to the nanoparticle into a nanopore by switching a voltage applied between the first and second electrodes to be applied between the first and a third electrodes or between the second and third electrodes.

### BRIEF DESCRIPTION OF THE DRAWINGS

These and/or other aspects will become apparent and more readily appreciated from the following description of the embodiments, taken in conjunction with the accompanying drawings of which:

FIG. 1 shows a microfluidic device for determining a nucleotide sequence of a target nucleic acid according to an embodiment of the present invention;

FIG. 2 is an enlarged diagram of a sample inlet disposed in the microfluidic device, according to an embodiment of the present invention;

FIG. 3 is a diagram for describing a method of determining a nucleotide sequence of a target nucleic acid by using a microfluidic device, according to an embodiment of the present invention;

FIG. 4 is a diagram for describing a method of determining a nucleotide sequence of a target nucleic acid in a nanopore of a microfluidic device, according to an embodiment of the present invention;

FIGS. 5A and 5B are diagrams for describing a method of determining a nucleotide sequence of a target nucleic acid by a probe mapping using a microfluidic device, according to an embodiment of the present invention; and

FIG. 6 is a diagram for describing a method of determining a nucleotide sequence of a single-stranded target nucleic acid by using a microfluidic device, according to an embodiment of the present invention.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein.

Accordingly, the embodiments are merely described below, by referring to the figures, to explain aspects of the present description.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof. All ranges and endpoints reciting the same feature are independently combinable.

It will be understood that when an element is referred to as being “on” another element, it can be directly on the other element or one or more intervening elements may be present. Also as used herein, the term “disposed on” describes the fixed structural position of an element with respect to another element, and unless otherwise specified should not be construed as constituting the action of disposing or placing as in a method step. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

According to an embodiment, there is provided a microfluidic device including: at least one first channel; and at least one second channel or chamber that is connected to the first channel via a nanopore in a fluid communication manner (i.e., so that a fluid can flow from the first channel to the second channel or chamber via the nanopore), wherein a first electrode and a second electrode are disposed in the first channel for applying a voltage in the lengthwise direction of the first channel, a first detector that detects a material in the first channel is disposed over the first channel, a third electrode is disposed in the second channel or chamber to be paired with the first or second electrode for applying a voltage between the first and third electrodes or between the second and third electrodes, and a second detector that detects a material passing through the nanopore is disposed in the nanopore. Herein, the first, second, and third electrodes are each in physical and electrical contact with the fluid and any solutes dissolved therein, as it passes through the respective channels.

The term “microfluidic device” as used herein refers to a device including at least one inlet and outlet which are connected to each other via a micro or nanochannel. The microfluidic device includes a micro or nanochannel or a micro or nanochamber for conducting a constant chemical reaction or analysis. The channel may have various cross-sections, such as for example, circular, rectangular, or trapezoidal in cross-section, but is not limited thereto.

The term “nanopore” used herein refers to a pore having a length along the central line having the narrowest cross-section ranging from about 1 to about 1,000 nm. If the cross-section of the pore is circular, the length is a diameter. The diameter of the narrowest cross-section of the pore may be in the range of about 1 to about 1,000 nm, for example, about 10 to about 1,000 nm. If the diameter is used to calculate an area of the cross-section, the area of the narrowest cross-section may be in the range of about 1 to about 8×10⁵ nm². In an embodiment, the micro- or nano-channel is greater in diameter or area than the nanopore. According to an embodiment, the diameter of the nanopore may be greater than the diameter of a single-stranded nucleic acid.

According to an embodiment, the microfluidic device may include at least one first channel and at least one second channel or chamber which is connected to the first channel via the nanopore in a fluid communication manner. For example, the first channel and the second channel or chamber may each be in common contact with side walls or bottom walls and be connected to each other via a nanopore formed in the common side walls or bottom walls in a fluid communication manner. In addition, the nanopore may have a channel shape and may connect the first channel and the second channel or chamber in a fluid communication manner.

The diameter of the first channel may be from about 10 to about 1,000 nm, for example, about 10 to about 100 nm. In addition, the diameter of the second channel or chamber may be from about 10 to about 1,000 nm, for example, about 10 to about 100 nm. According to an embodiment, the first channel includes openings at both ends, and the target material (i.e., a solute dissolved in the fluid) may pass through the first channel from one opening to the other opening. The target material may flow into or out of the second channel or chamber via the nanopore. The target material may thus be dissolved as a solute in a solution to form the fluid. The solution may be, for example, an aqueous solution, organic solution, or combination thereof. Where aqueous, the solution may have a broad pH range of, for example pH of 2 to 12.

The target material may include a material having a charge or induced charge. The target material may be selected from the group consisting of an organic material, an inorganic material, and combinations thereof. For example, the target material may be an organic material or a combination of an organic material and an inorganic material, and in particular, a complex including an organic material and an organic or organometallic molecule. Examples of the target material are nucleic acid or modified nucleic acid, such as DNA, RNA, peptide nucleic acid (“PNA”), and locked nucleic acid (“LNA”), polypeptide, or complexes thereof, but are not limited thereto. The complex may be prepared by linking a nucleic acid to a probe molecule that recognizes at least 2 base pairs (“bp”) of a sequence of the nucleic acid to be linked to the nucleic acid. In addition, a mediator that mediates the transfer of the target material may be used in order to transfer the target material in the channel. For example, a buffer solution that is known in the art to be suitable as a mediator may be used as the mediator without limitation.

According to an embodiment, a first electrode and a second electrode are disposed in the first channel for applying a voltage in the lengthwise direction of the first channel. The first and second electrodes may be disposed at both ends of the microfluidic device, for example, in the first channel. In addition, a voltage applied to the first electrode may have an opposite polarity to a voltage applied to the second electrode. For example, when a target material such as nucleic acid having negative polarity flows into the first channel, the voltage may be controlled such that the first electrode has negative polarity and the second electrode has positive polarity. In addition, the microfluidic device may further include a voltage controller that controls the polarity and/or magnitude of the voltage. The velocity of the target material (as dissolved in the fluid) flowing in the first channel may be controlled by the voltage controller.

According to an embodiment, the microfluidic device includes a first detector that detects the target material passing through the first channel, for example, exterior to or on an interior wall of or coaxial with the first channel. In addition, a second detector that detects a material passing through the nanopore may be disposed in the nanopore, for example, on an interior wall of the nanopore such that the target material is detected as it enters the nanopore and passes by the second detector.

The first or second detector may be an optical detector or an electrical detector. The electrical detector may detect at least one electrical property selected from the group consisting of current, voltage, resistance, impedance, and a combination thereof, and the optical detector may detect at least one optical property selected from the group consisting of absorbance, transmission, scattering, fluorescence, fluorescence resonance energy transfer (“FRET”), surface plasmon resonance, surface enhanced Raman scattering, diffraction, and a combination thereof. The second detector may be, for example, a nanoelectrode. If the second detector is a nanoelectrode, information of the nucleotide sequence may be directly obtained using difference in tunneling current of base, or information from a probe linked to the nucleic acid may be obtained using impedance, capacitance, conductance, and/or electrochemical methods.

According to an embodiment, a third electrode may be disposed in the second channel or chamber to be paired with the first and/or second electrode for applying a voltage between the first and third electrodes or between the second and third electrodes.

The third electrode may be disposed at any location within the second channel or chamber, for example, may be disposed on an interior surface in the second channel or chamber opposite from and facing the nanopore. The third electrode provides a driving force for changing the direction of the target material that migrates within the first channel toward the second channel or chamber via the nanopore. The voltage applied to the third electrode may have an opposite polarity to that applied to the first electrode and the same polarity as that applied to the second electrode. That is, in order to transfer the target material migrating in the first channel toward the second channel or chamber via the nanopore, a voltage applied between the first and second electrodes should be switched and applied between the first and third electrodes. For this, the microfluidic device may further include a voltage switching unit that switches the voltage applied between the first and second electrodes to be applied between the first and third electrodes or between the second and third electrodes.

According to an embodiment, the microfluidic device may further include a sample inlet and a sample outlet which are connected to openings of the both ends of the first channel in a fluid communication manner. The sample inlet may include a microfluidic region and a nanofluidic region, wherein the microfluidic region includes at least one microfluidic channel and the nanofluidic region includes at least one nanofluidic channel in fluid communication with the at least one microfluidic channel, and wherein the length of openings of the microfluidic channel or the nanofluidic channel disposed at boundaries between the microfluidic region and the nanofluidic region is reduced in a direction toward the nanofluidic region. The length of openings of the microfluidic channel or the nanofluidic channel may be reduced by about 10 to about 500 nm. Since the sample inlet includes the at least one microfluidic channel and the at least one nanofluidic channel which are disposed in a direction such that the diameter of the nanochannel decreases, a sample injected in the microfluidic device may spread therein by passing through the at least one microfluidic or nanofluidic channels. Finally, a single molecule of the target material may be allowed to flow more or less quickly into the first channel of the microfluidic device by adjusting the concentration of the target material or regulating the voltage applied to electrodes. For example, the target material may flow more rapidly into the first channel where the voltage is increased, or a greater number of molecules of the target material would be directed into the first channel where the concentration of target material is increased.

According to an embodiment, the microfluidic device may further include a converter that is connected to the second detector and converts a signal detected by the second detector into information of the nucleotide sequence of the target nucleic acid; and a calculator that determines the nucleotide sequence of the target nucleic acid based on the information obtained from the first detector and the converter. In addition, the converter may convert the signal generated by the second detector into location information for a target probe located on the target material.

The microfluidic device may further include an output unit that outputs the nucleotide sequence of the target nucleic acid determined by the calculator to a user.

According to another embodiment, there is provided a method of determining a nucleotide sequence of a target nucleic acid, the method including: linking a nanoparticle including a detectable label to a 5′ or 3′ end of a target nucleic acid having a nucleotide sequence to be detected; injecting the target nucleic acid linked to the nanoparticle into the first channel; applying a voltage between a first electrode and a second electrode of the microfluidic device; detecting a signal generated from the nanoparticle linked to the target nucleic acid passing through the first channel and including the detectable label; and introducing an end of the target nucleic acid which is not linked to the nanoparticle into a nanopore by switching the voltage applied between the first and second electrodes to be applied between the first and a third electrodes or between the second and third electrodes.

The method of determining a nucleotide sequence of a target nucleic acid will now be described in more detail.

The method includes linking a nanoparticle including a detectable label to a 5′ or 3′ end of a target nucleic acid having a nucleotide sequence to be detected.

The term “nanoparticle” used herein refers to a particle having a diameter of from about 1 to 100 nm. Components of the nanoparticle may include metal such as gold, silver, copper, aluminum, nickel, palladium, platinum, alloys thereof, a semiconductor material such as CdSe, CdS, InAs, InP, or core/shell structures thereof, an inert material such as polystyrene, latex, acrylate, polypeptide, or a combination thereof, but are not limited thereto.

The nanoparticle and the target nucleic acid may be linked to each other by a 1:1 covalent bond. For this, the nanoparticle may be chemically linked to the target nucleic acid, and the target nucleic acid linked to the nanoparticle may be isolated from unlinked target nucleic acids and nanoparticles. For example, the target nucleic acid linked to the nanoparticle may be isolated using magnetic characteristics of the nanoparticle, difference of electrophoresis rate, or physical characteristics such as size by adding excess target nucleic acid. A single functional group that is linkable to the nanoparticle may also be used. When a polypeptide is used, a functional group at a C- or N-terminal may be used. If the nanoparticle is a bead-shaped nanoparticle having more than one functional group, a single functional group among them may be used for the linkage. For example, a method of linking an oligo nucleic acid having a modified nucleotide at its end to a nanoparticle is disclosed by Nam et al., Nature Materials, 2010, vol 9, p. 60. The same effects as described above may be obtained by introducing a functional group into the oligo nucleic acid. In addition, in double-stranded DNA, a reaction by the functional group may occur at both ends, and thus DNA linked to the nanoparticle is isolated from DNAs and nanoparticles that are not linked to each other using an additional process.

The nanoparticle may be linked to a 5′ end or 3′ end of the target nucleic acid in order to enhance the stretch of DNA by accelerating or decelerating the transfer of the target nucleic acid in the first channel of the microfluidic device. In addition, the nanoparticle may include a detectable label so that the location of the target nucleic acid migrating within the first channel may be detected.

The term “nucleic acid” used herein refers to a ribonucleotide or a deoxyribonucleotide, or a polymer of a single-stranded ribonucleotide or a double-stranded deoxyribonucleotide. For example, the nucleic acid includes a genome sequence, a deoxyribonucleic acid (“DNA”; e.g., genomic DNA (“gDNA”) or complementary DNA (“cDNA”) sequence and a ribonucleic acid (“RNA”) sequence transcribed therefrom, and natural polynucleotide analogues, unless otherwise indicated herein. In addition, the target nucleic acid may be single-stranded or double stranded.

The term “detectable label” used herein refers to an atom, molecule, or particle used to specifically detect a molecule including the label among the same type of molecules without the label. For example, the detectable label may include colored bead, antigen determinant, enzyme, hybridizable nucleic acid, chromophore, fluorescent material, electrically detectable material, material providing modified fluorescence-polarization or modified light-diffusion, and quantum dot. In addition, the detectable label may include a labeled binding protein, a heavy metal atom, a spectroscopic marker such as a dye, and a magnetic label. The dye may be quinoline dye, triarylmethane dye, phthalene, azo dye, or cyanine dye, but is not limited thereto. The fluorescent material may be fluorescein, phycoerythrin, rhodamine, lissamine, or Cy3 or Cy5 (available from Pharmacia), but is not limited thereto.

In addition to voltage and concentration, the diameter of the nanoparticle may also influence the velocity of the target nucleic acid within the first channel. The nanoparticle may have a diameter suitable for passing through the first channel, for example, of about 1 to about 100 nm, or about 1 to about 10 nm. In addition, the nanoparticle may have the same polarity as a voltage applied to the first electrode so that the target nucleic acid strands linked to the nanoparticle are stretched in the first channel. In this regard, if the nanoparticle is charged, the intensity of the charge should be less than that of the voltage applied to the first electrode so that the target nucleic acid strands linked to the nanoparticle may migrate within the first channel.

The method includes injecting the target nucleic acid linked to the nanoparticle into the first channel of the microfluidic device.

For example, the target nucleic acid may be injected via a sample inlet disposed in the microfluidic device automatically using a sample injecting device (e.g., pump) or manually by a user. If the target nucleic acid is injected via the sample inlet, a single strand of a nucleic acid molecule may be injected into the first channel.

The method includes applying a voltage between the first electrode and the second electrode of the microfluidic device.

In this regard, a voltage applied to the first electrode may have an opposite polarity to a voltage applied to the second electrode. That is, since the target nucleic acid has negative polarity, the voltage may be applied to the first and second electrodes such that the first electrode has negative polarity and the second electrode has positive polarity in the microfluidic device according to an embodiment. Accordingly, the target nucleic acid flowed in the first channel migrates in a direction toward the second electrode.

The method includes detecting a signal generated from the nanoparticle including the detectable label and linked to the target nucleic acid passing through the first channel.

The signal generated from the nanoparticle including a detectable label and linked to the target nucleic acid may be detected by the first detector of the microfluidic device. The signal may vary according to the types of the detectable label, and examples thereof are described above. Since the location of the target nucleic acid within the first channel is recognizable by detecting the signal generated from the nanoparticle and a start point or an end point of the label linked to the target nucleic acid may be recognized, information required for determining the nucleotide sequence of the target nucleic acid may be provided.

The method includes introducing an end of the target nucleic acid which is not linked to the nanoparticle into a nanopore by switching a voltage applied between the first and second electrodes to be applied between the first and third electrodes or between the second and third electrodes.

According to an embodiment, when the first detector detects the signal generated from the nanoparticle including the detectable label and linked to the target nucleic acid while the target nucleic acid is migrating within the first channel by a voltage applied between the first and second electrodes, the voltage may be switched to be applied to the first and third electrodes. Since voltages having opposite polarities are applied to the first electrode and the third electrode disposed in the second channel or chamber by voltage switching, the target nucleic acid is attracted to the second channel or chamber. According to an embodiment, since the first channel is connected to the second channel or chamber in a fluid communication manner, the target nucleic acid migrates toward the second channel or chamber via the nanopore. In addition, since the nanoparticle is linked to one end of the target nucleic acid, the other end of the target nucleic acid which is not linked to the nanoparticle starts to migrate in a direction toward the second channel or chamber via the nanopore.

According to an embodiment, the method may further include making the target nucleic acid contact a probe including a detectable label after the linking.

The contact between the target nucleic acid and the probe may be conducted in vitro under stringent conditions known in the art and in a suitable buffer solution.

The term “probe” used herein refers to a nucleic acid or protein that is linkable to a target nucleic acid having complementary sequence by at least one chemical bond, generally complementary base paring, i.e., hydrogen bond between bases. The probe may be a nucleic acid or protein that is complementary to a part of the nucleotide sequence of the target nucleic acid. If the probe is a nucleic acid, the probe may generally include 4 to 100 nucleotides. Such base pair-recognition nucleotides for recognizing 2 by sequences may be of, for example, eight bases in length with a free hydroxyl group at the 3′ end, a fluorescent dye at the 5′ end and a cleavage site between the fifth and sixth nucleotide. If the probe is a protein, the sequence of amino acid that specifically recognizes the nucleotide sequence of the target nucleic acid in the target sequence-binding protein may include a nucleic acid-binding motif, and the protein may include at least one nucleic acid-binding motif. According to an embodiment, the sequence of the amino acid that is specifically linked to the sequence of the target nucleic acid may include at least one nucleic acid-binding motif selected from the group consisting of zinc finger motif, helix-turn-helix motif, helix-loop-helix motif, leucine zipper motif, nucleic acid-binding motif of restriction endonuclease, and combinations thereof. For example, amino acid sequences of zinc finger motifs may specifically recognize different nucleotide sequences. The probe may include a detectable label as described above.

According to an embodiment, the method may further include detecting a signal generated from the nucleotide sequence of the target nucleic acid or the probe linked to the target nucleic acid and including a detectable label by a second detector after the introducing.

The signal generated from the probe including the detectable label and linked to the target nucleic acid may be detected by the second detector in the microfluidic device. The signal may vary according to the types of the detectable label, and examples thereof are described above. The method may further include transferring the target nucleic acid linked to the nanoparticle toward the first channel by switching a voltage applied between the first and third electrodes or between the second or third electrodes to be applied between the first and second electrodes after the detecting. The transferring the target nucleic acid is conducted after the second detector detects the signal generated from the nucleotide sequence of the target nucleic acid or the probe including the detectable label and linked to the target nucleic acid while the target nucleic acid is migrating toward the second channel or chamber via the nanopore. That is, in order to discharge the target nucleic acid after the detection is completed, the voltage applied between the first and third electrodes or between the second and third electrodes is switched to be applied between the first and second electrodes to transfer the target nucleic acid toward the first channel via the nanopore. The target nucleic acid that arrives at the first channel may be transferred to a sample outlet and discharged. Alternatively, the target nucleic acid may pass through the nanopore and then be discharged into the second channel or chamber.

Information for the nucleotide sequence of the target nucleic acid or information of the probe which is detected by the second detector may be output to a user via the converter, the calculator, and the output unit as described above with reference to the microfluidic device.

The present invention will be described in further detail with reference to the following examples. These examples are for illustrative purposes only and are not intended to limit the scope of the invention.

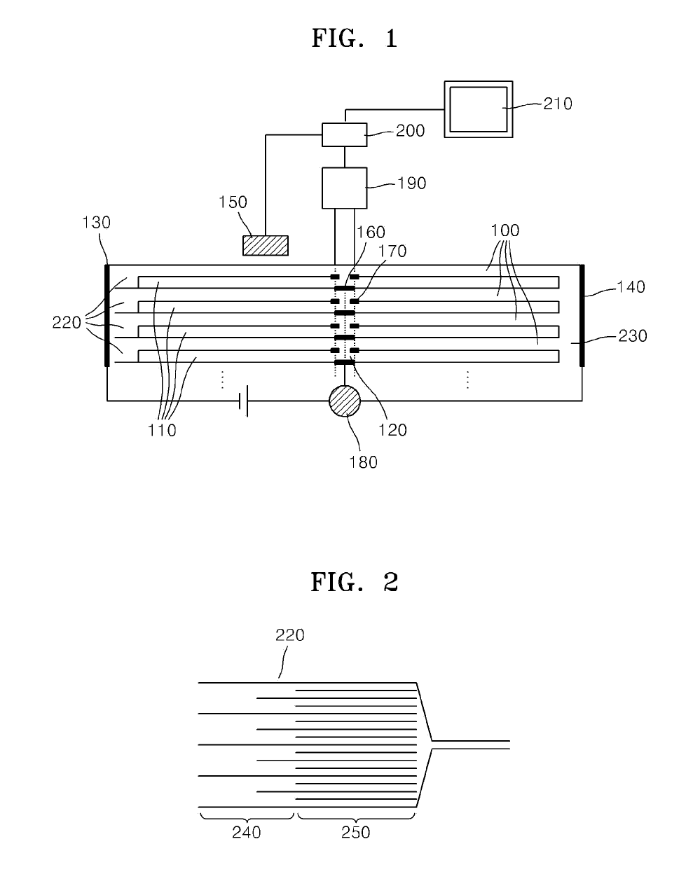

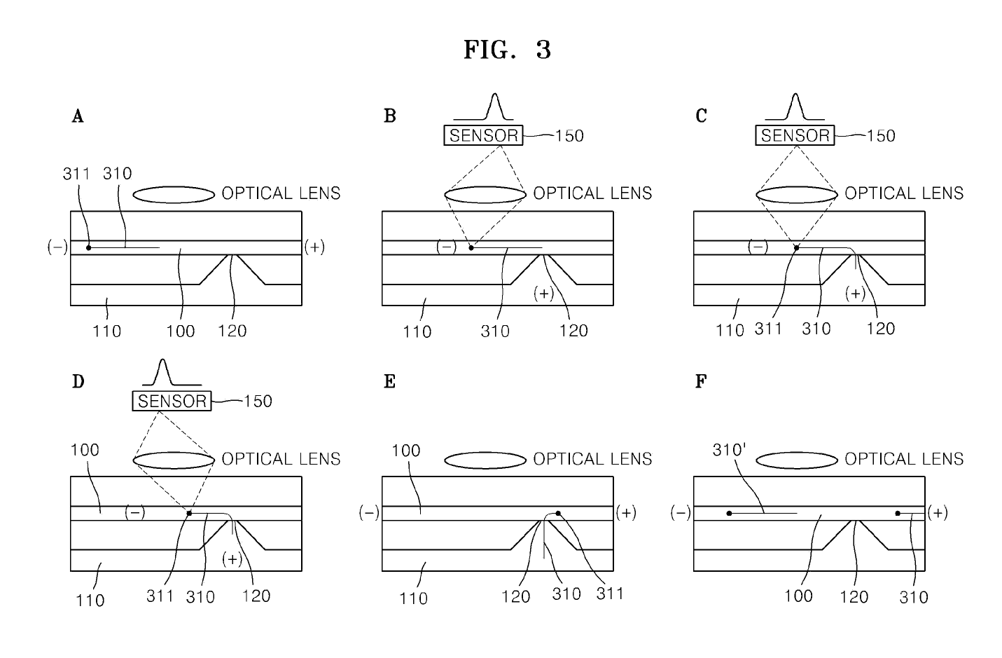

FIG. 1 shows a microfluidic device for determining a nucleotide sequence of a target nucleic acid according to an embodiment of the present invention. FIG. 2 is an enlarged diagram of a sample inlet that is disposed in the microfluidic device according to an embodiment of the present invention. FIG. 3 is a diagram for describing a method of determining a nucleotide sequence of a target nucleic acid by using a microfluidic device, according to an embodiment of the present invention.

The method of determining the nucleotide sequence of a target nucleic acid by using a microfluidic device will be described with reference to FIGS. 1, 2 and 3. First, in FIG. 1, a sample including a target nucleic acid is injected into a sample inlet 220 (FIG. 2) connected to a first channel 100 in a fluid communication manner. The target nucleic acid may be linked to a nanoparticle including an optically or electrically detectable label at the 5′ or 3′ end of the nucleic acid. Since (as shown in FIG. 2) the sample inlet 220 has a gradient structure of a plurality of channels including, along the direction of flow, microfluidic regions 240 and nanofluidic regions 250, the target nucleic acid injected into the sample inlet 220 is linearly stretched to orient the strands of target nucleic acid along the direction of flow, after passing through the microfluidic regions 240 and nanofluidic regions 250.

Thus, referring to FIG. 1, a single strand of the target nucleic acid injected into the first channel 100 migrates in a direction toward the second electrode 140 by a negative voltage applied to the first electrode 130 and a positive voltage applied to the second electrode 140. This is further illustrated in FIG. 3A, in which target nucleic acid 310 (having nanoparticle 311 attached thereto) flows down first channel 100 toward nanopore 120 along the direction from (−) to (+). The target nucleic acid may thus migrate as a stretched structure within the first channel 100 by the nanoparticle linked to the target nucleic acid and the nanochannel structure. In addition, the nanoparticle decelerates the migration of the target nucleic acid.

Also in FIG. 1, a first detector 150 detects an optical and/or electrical signal from a detectable label of the nanoparticle linked to the target nucleic acid that migrates within the first channel 100. According to an embodiment, the signal detected by the first detector 150 indicates that the target nucleic acid is close to a nanopore 120. In order to detect the nucleotide sequence of the target nucleic acid passing through the nanopore 120, a voltage may be switched such that the target nucleic acid passes through the nanopore 120. That is, a voltage applied between the first electrode 130 and the second electrode 140 may be switched so that the voltage becomes applied between the first electrode 130 and a third electrode 160. A voltage switching unit 180 switches the voltage from the first electrode 130 and second electrode 140, to the first electrode 130 and the third electrode 160, and the target nucleic acid is attracted to the second channel or chamber 110 by the switched voltage. This is further illustrated in FIG. 3B, in which the nanoparticle 311 attached to target nucleic acid 310 is detected by first detector 150 (an optical detector as illustrated) as it approaches nanopore 120 flows down first channel 100 toward nanopore 120, and the positive electrode is switched from the second electrode 140 (not shown) to the third electrode 160 (not shown), where the positive charge (+) is now beneath nanopore 120. Thus, an end of the target nucleic acid 310 which is not linked to the nanoparticle 311 begins migrating in a direction toward the second channel or chamber 110 via the nanopore 120 while nanoparticle 310 is monitored by first detector 150 as seen in FIGS. 3C and 3D.

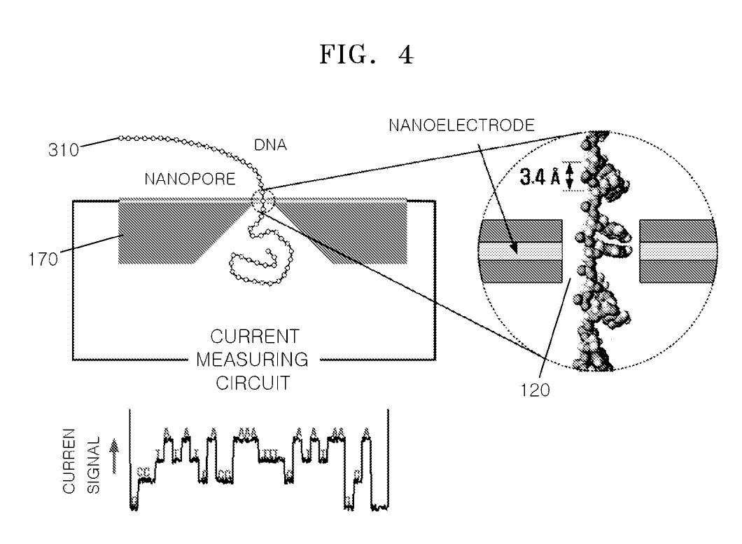

In FIG. 4, a signal from the target nucleic acid 310 passing through the nanopore 120 may be detected by the second detector 170 (see also FIG. 1). The second detector 170 may be a nanoelectrode, i.e., an electrode having nanoscale dimensions similar to that of the nanopore, e.g., of a dimension of about 1 to about 100 nm. In this case, information of the nucleotide sequence may be directly obtained using the difference in baseline tunneling current or impedance (see e.g., FIG. 4, plot of current signal by exemplary base pair adenine (A), thymine (T), cytosine (C), and guanine (G)). The nanoelectrode may further have a thickness (i.e., dimension along the axis of flow for the target nucleic acid 310) of equal to or less than 1 nm, as shown in cross-sectional view in FIG. 4.

In order to determine the nucleotide sequence of the target nucleic acid in FIG. 1, a converter 190 converts the signal detected by the second detector 170 into information for the nucleotide sequence of the target nucleic acid, and a calculator 200 calculates location information, i.e., a start point, of the target nucleic acid obtained by the first detector 150 and the signal obtained by the converter 190. The information of the determined nucleotide sequence may be sent as output to a user by an output unit 210.

In FIGS. 1 and 3, after the nucleotide sequence of the target nucleic acid 310 is determined while passing toward the second channel or chamber 110 via the nanopore 120 as shown in FIG. 3E, the voltage switching unit 180 (FIG. 1; not shown in FIG. 3), which is controlled by a signal from first detector 150 detecting the nanoparticle, no longer detects the nanoparticle 311 and switches the voltage applied between the first electrode 130 and the third electrode 160 to be applied between the first electrode 130 and the second electrode 140 so that the target nucleic acid 310 migrates toward the first channel 100 (FIG. 1; electrodes not shown in FIG. 3). The target nucleic acid that arrives at the first channel 100 is transferred to a sample outlet 230 (FIG. 1) and discharged. This is further illustrated in FIG. 3F, in which a molecule of the target nucleic acid 310 flows down first channel 100 to sample outlet 230 (not shown), as another molecule of target nucleic acid 310′ flows down first channel 100, and the process is repeated. Alternatively, or in addition, the target nucleic acid 310 may pass through the nanopore 120, and then be discharged to the second channel or chamber 110. For this, a functional group capable of electrically or optically separating the nanoparticle from the target nucleic acid may be introduced between the nanoparticle and the target nucleic acid.

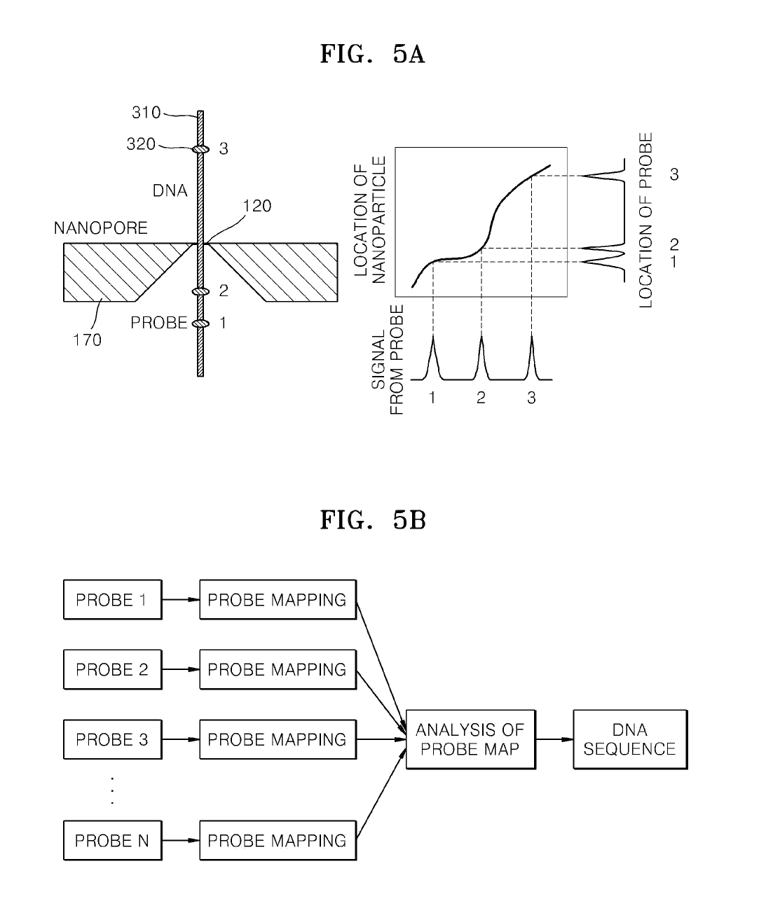

FIGS. 5A and 5B are diagrams for describing a method of determining a nucleotide sequence of a target nucleic acid by a probe mapping by using a microfluidic device, according to an embodiment.

The nucleotide sequence of the target nucleic acid may be determined by probe mapping using the microfluidic device according to an embodiment. As shown in FIG. 5A, for the probe mapping, the method of determining the nucleotide sequence of the target nucleic acid 310 according to an embodiment may further include making the target nucleic acid 310 contact a nucleic acid or protein probe 320 (x, y, z) that is complementary to a part of the nucleotide sequence of the target nucleic acid 310 and includes an optically or electrically detectable label. In addition, the second detector 170 may detect a signal generated from the detectable label of the probe and the converter 190 (see FIG. 1; not shown in FIG. 5A) may convert the signal into information of the nucleotide sequence of the target nucleic acid. Also in FIG. 1, the calculator 200 collects information of the nucleotide sequence converted by the converter 190 and calculates and analyzes a probe map, and the output unit 210 outputs the information of the nucleotide sequence of the target nucleic acid to a user. FIG. 5A further shows a probe map where the signal from each probe 320 (individually referred to for illustrative purposes as 1, 2, and 3) is translated based on the location of the nanoparticle (as determined by the first detector 150, not shown), to correspond to the location of each probe. FIG. 5B shows in sequential form that information is obtained for each of probes 1, 2, 3, . . . n, followed by probe mapping for each probe, and the probe maps analyzed to determine a sequence for the nucleotide. The other processes are the same as those described above with reference to the method of determining a nucleotide sequence of a target nucleic acid.

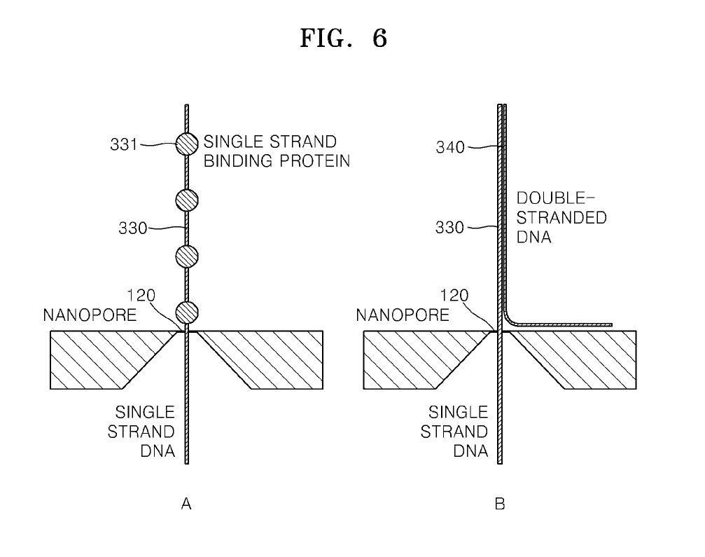

FIG. 6 is a diagram for describing a method of determining a nucleotide sequence of a single-stranded target nucleic acid by using a microfluidic device according to an embodiment.

In FIG. 6A, a single-stranded target nucleic acid may be used for the detection of the nucleotide sequence. If the second detector 170 is a nanoelectrode, the single-stranded target nucleic acid should pass through the nanopore 120. However, it may be difficult to stably maintain the length of the single-stranded target nucleic acid in a buffer solution. Thus, in FIG. 6A, the single-stranded target nucleic acid 330 may be further stabilized using a single strand binding protein 331, or in FIG. 6B, a part of the target nucleic acid 330, i.e., a part of the target nucleic acid 330 which does not pass through the nanopore 120, may be double-stranded (i.e., may include a second strand 340), so that a long target nucleic acid may be used in the buffer solution.

According to the microfluidic device and the method of determining a nucleotide sequence of a target nucleic acid by using the same, the nucleotide sequence of the target nucleic acid may be efficiently determined.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A microfluidic device comprising: at least one first channel; and at least one second channel or chamber connected to the first channel via a nanopore in a fluid communication manner, wherein a first electrode and a second electrode are disposed in the first channel for applying a voltage in the lengthwise direction of the first channel, a first detector that detects a material in the first channel is disposed over the first channel, a third electrode is disposed in the second channel or chamber to be paired with the first or second electrode for applying a voltage between the first and third electrodes or between the second and third electrodes, and a second detector that detects a material passing through the nanopore is disposed in the nanopore.

2. The microfluidic device of claim 1, wherein the diameter of the nanopore is about 1 to about 100 nm.

3. The microfluidic device of claim 1, wherein the diameter of the first channel is about 10 to about 100 nm.

4. The microfluidic device of claim 1, wherein the diameter of the second channel or chamber is about 10 to about 1,000 nm.

5. The microfluidic device of claim 1, wherein the first detector and second detector are independently an optical detector or an electrical detector.

6. The microfluidic device of claim 5, wherein the electrical detector detects at least one property selected from the group consisting of a current, voltage, resistance, impedance, and a combination thereof.

7. The microfluidic device of claim 5, wherein the optical detector detects at least one property selected from the group consisting of an absorbance, transmission, scattering, fluorescence, fluorescence resonance energy transfer, surface plasmon resonance, surface enhanced Raman scattering, diffraction, and a combination thereof.

8. The microfluidic device of claim 1, further comprising a voltage switching unit that switches voltage applied between the first and second electrodes to be applied between the first and third electrodes or between the second and third electrodes.

9. The microfluidic device of claim 1, further comprising a converter that is connected to the second detector and converts a signal detected by the second detector into information of the nucleotide sequence of the target nucleic acid; and a calculator that determines the nucleotide sequence of the target nucleic acid based on the information obtained from the first detector and the converter.

10. The microfluidic device of claim 1, further comprising a converter that is connected to the second detector and converts a signal detected by the second detector into location information of a target probe; and a calculator that determines the nucleotide sequence of the target nucleic acid based on the information obtained from the second detector and the converter.

11. The microfluidic device of claim 9, further comprising an output unit that outputs the nucleotide sequence of the target nucleic acid determined by the calculator to a user.

12. The microfluidic device of claim 10, further comprising an output unit that outputs the nucleotide sequence of the target nucleic acid determined by the calculator to a user.

13. The microfluidic device of claim 1, further comprising a sample inlet and a sample outlet which are connected to openings of both ends of the first channel in a fluid communication manner.

14. The microfluidic device of claim 13, wherein the sample inlet comprises a microfluidic region and a nanofluidic region, wherein the microfluidic region comprises at least one microfluidic channel and the nanofluidic region comprises at least one nanofluidic channel in fluid communication manner with the at least one microfluidic channel, and wherein the length of openings of the microfluidic channel or the nanofluidic channel disposed at boundaries between the microfluidic region and the nanofluidic region is reduced in a direction toward the nanofluidic region.

15. The microfluidic device of claim 14, wherein the length of openings of the microfluidic channel or the nanofluidic channel is reduced by about 10 to about 500 nm.

16. A method of determining a nucleotide sequence of a target nucleic acid, the method comprising:
linking a nanoparticle comprising a detectable label to a 5′ or 3′ end of a target nucleic acid having a nucleotide sequence to be detected;
injecting the target nucleic acid linked to the nanoparticle into a first channel according to claim 1;
applying a voltage between a first electrode and a second electrode of the microfluidic device;
detecting a signal generated from the nanoparticle comprising the detectable label and linked to the target nucleic acid passing through the first channel; and
introducing an end of the target nucleic acid which is not linked to the nanoparticle into a nanopore by switching a voltage applied between the first and second electrodes to be applied between the first and a third electrodes or between the second and third electrodes.

17. The method of claim 16, wherein the diameter of the nanoparticle is about 1 to about 100 nm.

18. The method of claim 16, wherein the target nucleic acid is single-stranded or double-stranded.

19. The method of claim 16, further comprising isolating the target nucleic acid linked to the nanoparticle from the target nucleic acids and nanoparticles which are not linked after the linking.

20. The method of claim 16, further comprising making the target nucleic acid contact a probe including a detectable label after the linking.

21. The method of claim 20, wherein the probe is a nucleic acid or protein that is complementary to a part of the nucleotide sequence of the target nucleic acid.

22. The method of claim 16, further comprising detecting a signal generated from the nucleotide sequence of the target nucleic acid or from the probe linked to the target nucleic acid and comprising a detectable label by a second detector after the introducing.

23. The method of claim 22, further comprising transferring the target nucleic acid linked to the nanoparticle toward the first channel by switching a voltage applied between the first and third electrodes or between the second or third electrodes to be applied between the first and second electrodes after the detecting.

24. The microfluidic device of claim 16, wherein the detectable label is selected from the group consisting of a colored bead, antigen determinant, enzyme, hybridizable nucleic acid, chromophore, fluorescent material, electrically detectable material, material providing modified fluorescence-polarization or modified light-diffusion, quantum dot, and a combination thereof.
